(19) United States
(12) Patent Application Publication
(10) Pub. No.: US 2005/0097516 A1
(43) Pub. Date: May 5, 2005

(54) Extensible and dynamically-configurable problem-reporting client

(75) Inventors: Paul Harold Donnelly II, Newcastle, WA (US); Douglas A. Anderson, Kirkland, WA (US)

Correspondence Address: LEYDIG, VOIT & MAYER, LTD., TWO PRUDENTIAL PLAZA, SUITE 4900, 180 NORTH STETSON, CHICAGO, IL, 60601-6780, US

(73) Assignee: Microsoft Corporation, Redmond, WA (US)

(21) Appl. No.: 10/701,821

(22) Filed: Nov. 5, 2003

(51) Int. Cl. G06F 9/44

(52) U.S. Cl. 717/124; 717/120

(57) ABSTRACT

A system and method is disclosed for facilitating the reporting of information regarding a computer software product by way of a dynamically-configurable general report client. The general report client is used along with a set of report user interface definition files that is specific to each software product for which a report can be prepared. A set of report user interface definition files customizes the report user interface for reporting information relating to the software product with which it is associated. The invention provides for dynamic configurability in that, by entering certain values by way of the report user interface, the user may cause the client to load additional report user interface definition files and present additional user interface child screens accordingly. The invention provides methods by which software developers, software providers and others obtain user feedback for such purposes as beta-testing and debugging.

### TECHNICAL FIELD OF THE INVENTION

The present invention relates generally to computer systems, and more particularly to methods and mechanisms for issue reporting by software users to software developers and providers.

### BACKGROUND OF THE INVENTION

In general, it is impossible to guarantee that a computer program is free of bugs. Computer software projects of substantial scope and complexity are particularly likely to contain errors and other unexpected and undesirable behavior. In order to develop and maintain useful, high-quality software products while minimizing errors and other problems, it is essential that software developers receive informative feedback from users. The task of collecting and analyzing sufficiently-detailed user experience information in order to make appropriate improvements to software is especially challenging in large-scale projects involving a widely-dispersed user base. One important setting in which the need for such a task arises is the beta-release stage of software under development.

Utilities have been designed to facilitate submission of reports on bugs and other issues from users to developers. Most previous reporting tools and trouble ticket mechanisms have been tied to particular applications, products or platforms. Other reporting tools have been limited to allowing highly general diagnostic questions to be presented to the user. Changes to and extensions of existing tools have required substantial, time-consuming recoding efforts.

### SUMMARY OF THE INVENTION

The present invention is directed to a system and method in which a dynamically-configurable general report client is used to facilitate reporting of information, such as a bug or other problem issue, regarding a computer software product. The invention is capable of being used for reporting on an arbitrary number of different software products. In accordance with the invention, a particular report user interface is specified for each product with respect to which a report can be prepared. A set of one or more report user interface definition files specifies a customized user interface for a particular product. The client causes a display of the customized report user interface in accordance with the report user interface definition files. In certain embodiments of the invention the report user interface definition files are Extensible Markup Format (XML) files or other markup-language files. Report user interface definition files may include a report parent file along with one or more additional report user interface definition files.

In accordance with one aspect of the present invention, there is provided a system for reporting information regarding the use of one or more software products by a software user. The system includes a report user interface, a set of report user interface definition files associated with each software product that can be the subject of a report, and the general report client. The software user enters requested information, as specified in the report user interface definition files, by way of the report user interface. The client generates a report file based on the information entered by the user and packages the report file with additional report information, such as hardware configuration information regarding the user's machine, required supporting files and user-supplied supporting files, and user authentication information, and transmits the package to a report server. The user can save an incomplete report in one session of running the client and complete and upload the report in a subsequent session.

In accordance with another aspect of the present invention, there is provided a method by which a software developer, provider or other party can obtain reported information regarding the use of a software product, as for example the use by a beta-testing customer. One or more report user interface definition files associated with that software product are designed to specify a customized user interface displayed by a general report client. Based on information reported by a user, the report user interface definition files can be modified for purposes of future reporting.

In accordance with another aspect of the invention, a method for debugging a computer program is provided. One or more report user interface definition files are written. The report user interface definition files, designed for use with a general report client, specify a report user interface that is customized for reporting on the computer program being debugged. By way of the report client, bug information reported by a user of the computer program is obtained. Based on this reported bug information, source code for the computer program is modified. The report user interface definition files can also be modified for purposes of future debugging of the computer program.

In accordance with another aspect of the invention, there is provided a method by which a user reports information regarding the use of a software product. The user runs a general report client. The user causes the client to load one or more report user interface definition files customized with respect to the software product. The user enters information by way of a report user interface displayed by the client in accordance with the report user interface definition files. Entering certain information may cause the client to load one or more additional report user interface definition files and accordingly add one or more additional child screens to the user interface. The user causes the client to upload a completed report to a server. In embodiments of the invention, the user can submit a report anonymously, and the user can save an incomplete report in a first session in which the report client is run, completing the incomplete report in a subsequent client session.

In accordance with another aspect of the invention, there is provided a method for authenticating a user who submits a report on a software product. A report cookie, comprising a report user identification and an expiration date, is generated for the reporting user. In embodiments of the invention, the report user identification is a cryptographically-random signed 64-bit integer, and the generating of the report cookie is performed by way of a web service. The report cookie is stored in a ticket file on the reporting user's computer. In an embodiment of the invention, the ticket file is an XML file.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings, of which:

FIG. 1 is a schematic diagram identifying several primary components in a problem reporting framework in accordance with an embodiment of the present invention;

FIG. 2 is a block diagram identifying primary components associated with a problem-reporting client in accordance with an embodiment of the present invention;

FIG. 3 is a flowchart summarizing an exemplary set of steps for obtaining software user feedback in an embodiment of the invention;

FIG. 4 is a flowchart summarizing an exemplary set of steps for completing and submitting a problem report in accordance with an embodiment of the invention;

FIG. 4A is a flowchart summarizing an exemplary set of steps relating to user authentication in accordance with the embodiment of the invention illustrated in FIG. 4;

FIG. 5 provides an exemplary image of a basic user interface display in accordance with an embodiment of the invention;

FIG. 6 provides an exemplary image of a dynamically-generated additional information child screen in accordance with an embodiment of the invention;

FIG. 7 provides an exemplary image of a requested files child screen in accordance with an embodiment of the invention;

FIG. 8 provides an exemplary image of a save screen in accordance with an embodiment of the invention;

FIG. 9 provides an exemplary image of an authentication service login screen in accordance with an embodiment of the invention; and

FIG. 10 is a simplified schematic diagram illustrating an exemplary architecture of a computing device for incorporating and carrying out aspects of an embodiment of the present invention.

### DETAILED DESCRIPTION

Disclosed herein is an illustrative system architecture in accordance with which a single client installed on a user's computer is used to submit reports on multiple software products to one or more reporting servers, possibly by way of a remote network connection. The template format for a given report is specified in a manner that is customized for a corresponding software product. Based on initial user responses, a report can be further dynamically configured to request additional information from the user. Also disclosed herein is a method by which developers and providers of a software product obtain problem reports from users and accordingly modify both the software product and the report template files designed for user reports on that product. Also disclosed herein is a method by which a user prepares and submits, to one or more reporting servers, issue reports on one or more software products, along with supporting information, using a single problem-reporting client. Also disclosed herein are customizable features of an exemplary user interface design for a problem-reporting client.

While this detailed description will refer to illustrative embodiments of the invention that provide specifically for the preparation and submission of bug reports or issue reports, it will be recognized that the invention applies more broadly to communication between software users and software providers in general, including the submission of other kinds of user information besides issue reports. For example, alternative embodiments of the present invention are employed in the provision of support to a user of a software product where the user has not experienced a bug but seeks assistance in the use of the product.

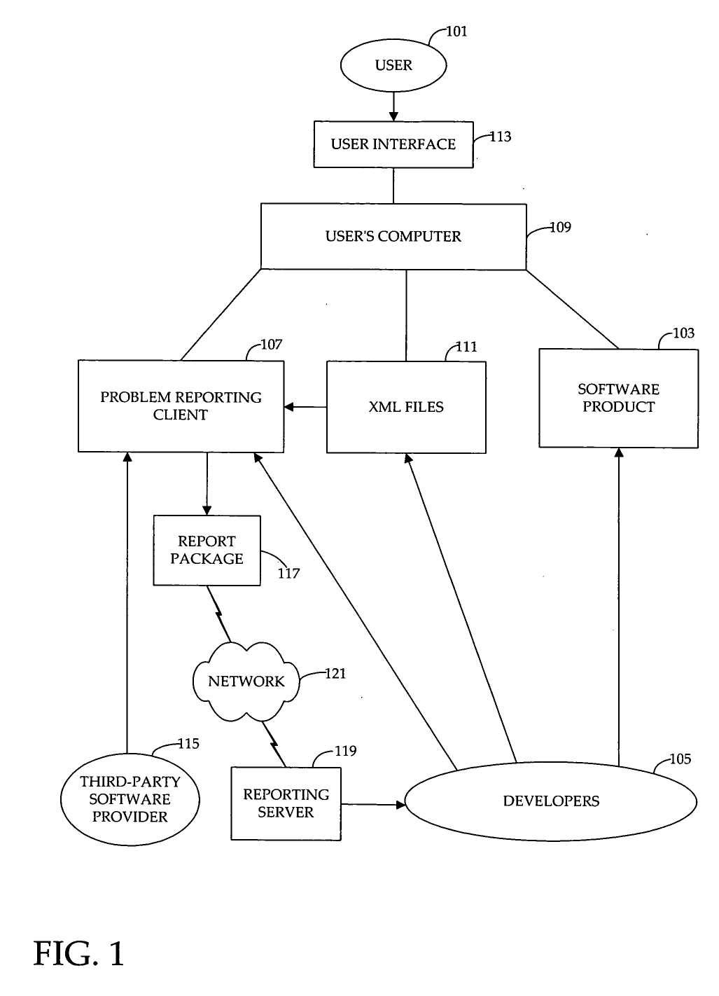

Turning to FIG. 1, a high-level view of the structure of an illustrative embodiment of the invention is shown. The invention facilitates product-specific communication between a user 101 of a computer software product 103 and the providers of the product, such as the product developers 105. An executable problem-reporting client application 107 is installed on the user's computer 109. Also stored on the user's computer 109 are the software product 103, comprising an executable computer program, and a set of text files 111 formatted in accordance with the Extensible Markup Language (XML) and associated with the product 103. The XML files 111 define all the features of a customized problem-reporting user interface 113 for the product 103, and the client 107 constructs the interface 113 based on the specifications in these files 111. The user interface 113 comprises a questionnaire form containing questions directed to the use of the product 103 along with answers and other responsive information provided by the user 101. While the description herein refers to an embodiment that uses XML files to specify the problem-reporting user-interface, those skilled in the art will appreciate that alternative embodiments may use other kinds of data formats to define the interface.

The problem-reporting client 107 is provided to the user 101 by, for example, the developers 105 of the software product 103 or by a third-party software provider 115. By way of example, the user interface-defining XML files 111 associated with the software product 103 are produced by the developers 105 and provided to the user 101 at the time at which the software product 103 itself is provided, or at a separate time. The user 101 is, for example, a customer selected by the developers 105 to participate in beta-release testing of the product 103.

If the user 101 experiences a bug or other problem or issue with respect to the use of the software product 103, the user 101 runs the problem-reporting client 107 in order to begin a new report or complete a report in progress on the encountered issue by way of the problem-reporting user interface 113. The client 107 packages the user's responses together with additional data, such as supporting files and hardware information, into a report package 117. If the user 101 chooses to upload the completed report package 117, the client 107 transmits the package 117 to a problem-reporting server 119, where the reported information will be parsed into a database. The developers 105 of the software product 103 for which the report 117 was completed will then retrieve information relating to the problem report 117. Typically the server 119 will be remote to the client 107 and to the user's computer 109, and the transmission occurs by way of a network 121.

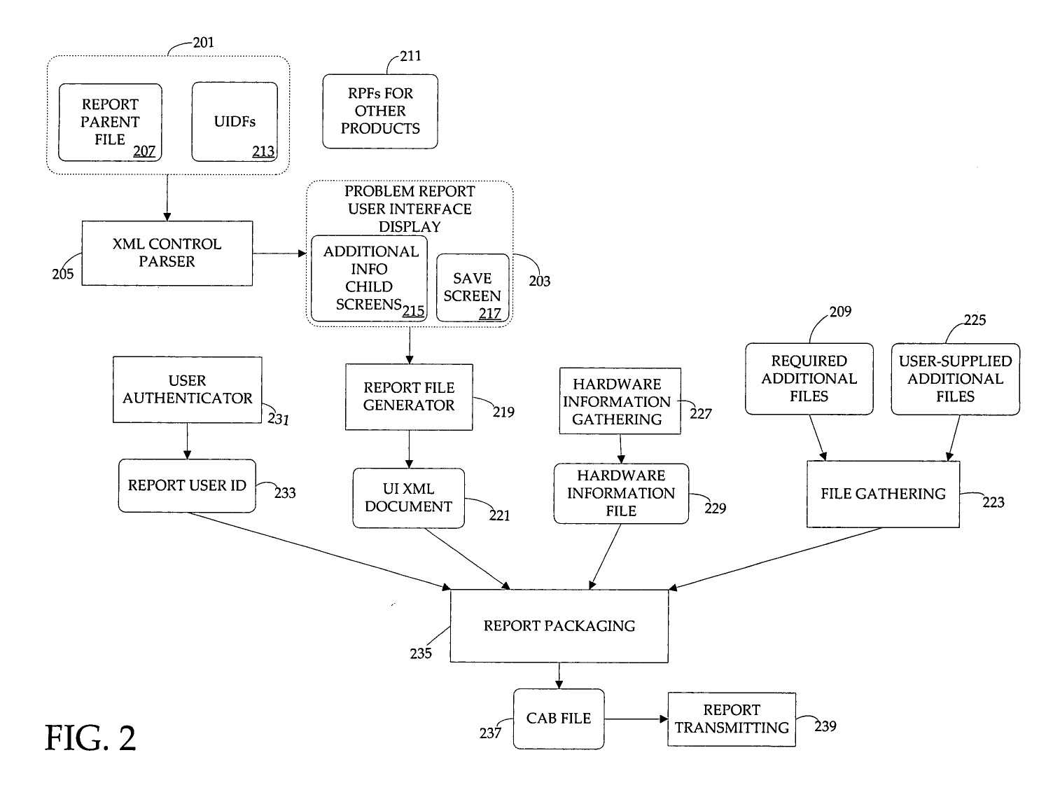

Turning now to FIG. 2, the primary components of a problem-reporting client and related elements in accordance with an embodiment of the invention are illustrated in further detail. A collection of XML files 201 stored on a user's computer, and customized for a particular software product, specifies graphics, text, input controls, and other characteristics and features of a user interface display 203 for preparing a problem report relating to the software product. The user interface 203 can be regarded as comprising questions presented to the user, responses entered by the user, and related resources made available to the user, such as controls for saving and uploading a report and for accessing help information. An XML control parser 205 parses the XML files 201 in order to fashion the user interface 203. The user interface 203 is presented to the user as a set of interconnected screens allowing for the submission of requested information.

The set of XML files 201 includes a top-level file called the Report Parent File (RPF) 207, marked in an embodiment by a file name with an .rpf extension. The RPF 207 contains definitions of user interface design elements specifying the base features and layout of the report user interface 203, such as colors, graphics elements, window heights and widths, and the positions, sizes, and captions of controls common to all windows in the display 203. The RPF can also include a list of additional files 209 stored on the user's system that are considered to be required or useful for processing a submitted user report.

One or more additional RPFs 211, each associated with a particular other software product, may be present on a user's system. In an embodiment of the invention, when the client is launched by the user, the client loads the RPF most recently loaded in a previous execution of the client. If the client is being run for the first time, or there is no record of the most recently loaded RPF, or if the most recently loaded RPF is not present on the user's system, the client loads the first valid RPF it finds. A well-written RPF will define a drop-down list display element that enumerates all RPFs 207, 211 stored on the user's system, permitting the user to change the report template being used for preparing a current report. An RPF file ideally will be given an intuitively meaningful file name, such as one identifying the product for which it is customized.

The RPF 207 can contain a list of user interface definition files (UIDFs) 213, which are additional files in the set of XML files 201. A particular UIDF defines controls that specify all elements of a corresponding “child screen” within the report display 203, including all questions and requests for additional files or additional supporting information that will be presented to the user in that child screen. The UIDF also specifies whether a response to a particular question is required in order for the corresponding child screen to be considered completely filled out. A typical report user interface 203 will incorporate several child screens, each of which is based on a particular UIDF.

In accordance with controls defined in the RPF 207 and specified files in the set of UIDFs 213, when the user selects or inputs particular values in a display screen, an appropriate UIDF is loaded by the client and parsed by the control parser 205. The questions defined in that UIDF are thereby incorporated into the user interface 203 presented to the user. In this way, the problem-reporting client is dynamically configurable. A potentially unlimited number of questions or other requests for information can be added to the user interface 203 during the course of a user's completion of a problem report. For example, within a software product development team, a group of developers may be responsible for a particular component of the software product. This group can define additional user interface child screens in one or more UIDFs for the purpose of obtaining more detailed information from the user pertaining to the component for which they are responsible. Based on the user's responses, progressively more finely-grained content, in the form of “additional information” child screens 215, can thus be added to the user interface 203 dynamically by loading additional UIDFs in the set of UIDFs 213.

In addition to the dynamically-defined child screens 215, the problem report user interface 203 will have a “save screen” 217, a child screen providing instructions to the user on saving and submitting a report. The text strings and other display characteristics of the save screen 217 are defined in the RPF 207 and can be customized (as for example by language and writing system). The user is not required to submit a report during the client session in which the report is first prepared; an incomplete report is saved by the user for future editing and completion. This permits the user to locate information needed to complete a problem report questionnaire.

When a user has completed a problem report, and the problem-reporting client verifies the report as having been filled out completely, a report file generator 219 compiles the user's responses into a properly-formatted user interface XML document 221 and cryptographically signs the document. A file gathering component 223 defines a user interface feature comprising a file list, and brings about the collection of additional files to be submitted with the report, including required files 209 specified in the RPF 207, such as relevant system log files and files supplied by the user 225. A hardware information gathering component 227 extracts information concerning the configuration of the user's machine and saves this information in a hardware information XML file 229. A user authentication component 231 supplies user identification credentials 233 to be included with the problem report if the user wishes to be contacted in the future regarding the submitted report. An embodiment of the invention uses the Microsoft® .NET Passport authentication service, in a manner described in further detail below.

A report packaging component 235 packages the report XML document 221 along with the files 209, 225 gathered by the file gathering component 223, the hardware information file 229 generated by the hardware information gathering component 227 (unless the user has opted not to have this information submitted with the report), and the report user identification credentials 233 produced by the user authentication component 231, into a cabinet (.cab extension) file 237. In an alternative embodiment, another file archive format is used. A report transmitting component 239 causes the cabinet file 237 to be uploaded to a reporting server, where it is parsed and sorted into an appropriate database based on such criteria as user status, program participation, and product.

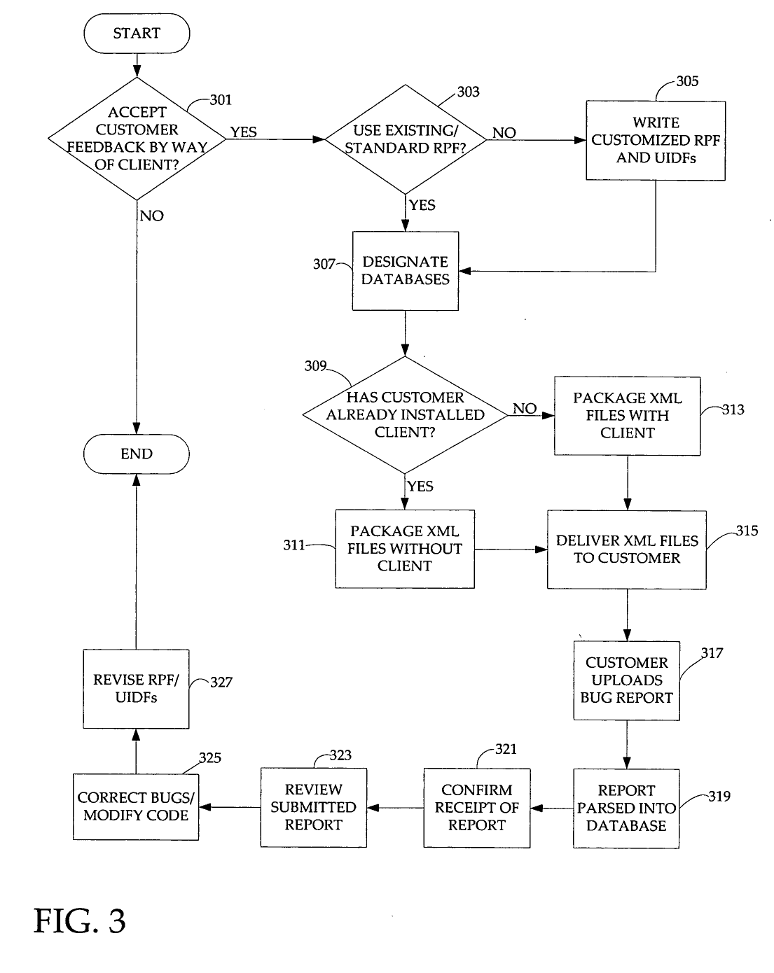

Turning now to FIG. 3, there is shown a flowchart illustrating an exemplary set of steps for obtaining software user feedback in an embodiment of the invention, from the perspective of a manager of a software development group. Such a process might take place, for example, in the case of a software product already in beta release or about to be beta-released to a set of authorized customers. At step 301 the manager decides to accept feedback from customers by way of a problem-reporting client in accordance with the invention. During step 303 the manager decides whether to use an existing or standard RPF. If not, during step 305 a customized RPF is written, possibly along with one or more UIDF XML files. During step 307 the manager designates one or more target product feedback or bug-tracking databases for storage of information parsed from uploaded problem reports on the product. With respect to a particular customer, if it is determined, at step 309, that the customer has already installed the problem-reporting client, then the XML files are packaged separately for distribution to that customer during step 311. Otherwise, at step 313, the XML files are packaged together with the client. In either case, at step 315 the XML files are delivered to the customer. During step 317 the customer, using the problem-reporting client, uploads a bug or issue report to a reporting server. During step 319 the reported data is parsed into the designated bug-tracking database or databases. If the customer has provided a contact e-mail address, at step 321 the customer is sent a message confirming receipt of the report. The manager and developers review submitted report information during step 323, and correct or modify software code accordingly during step 325. During step 327, for purposes of future reporting, the questions presented to the customer by way of the problem-reporting client are modified by the development team by producing new RPFs and UIDFs.

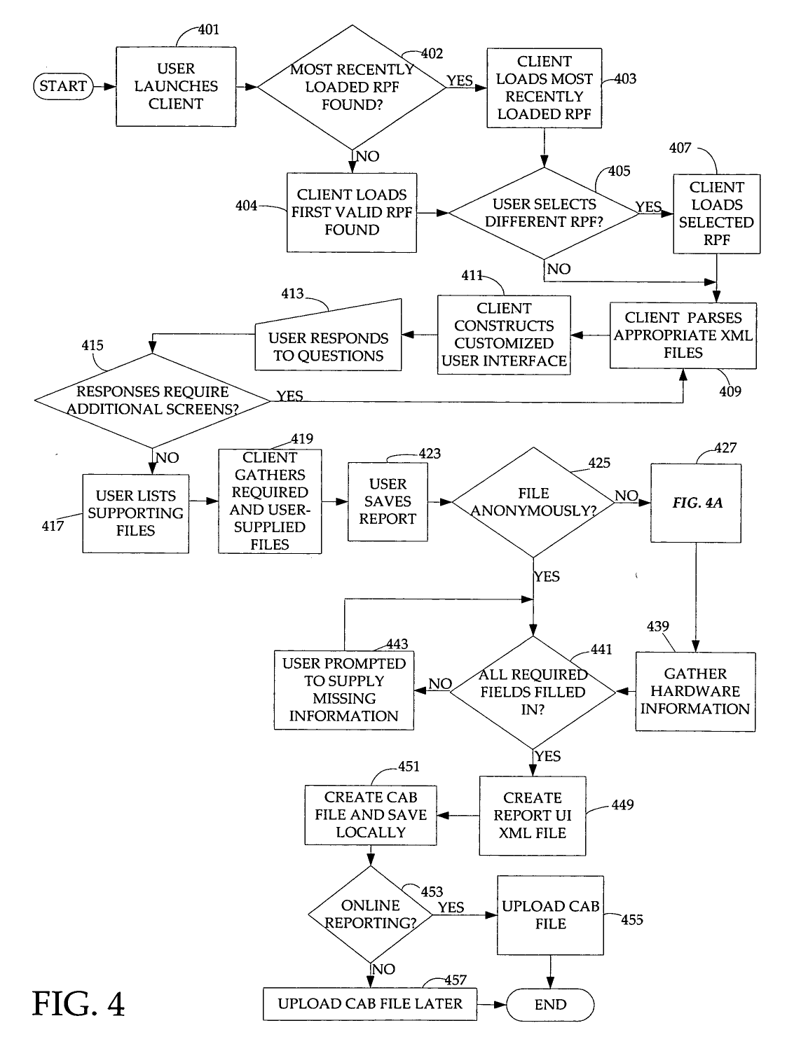

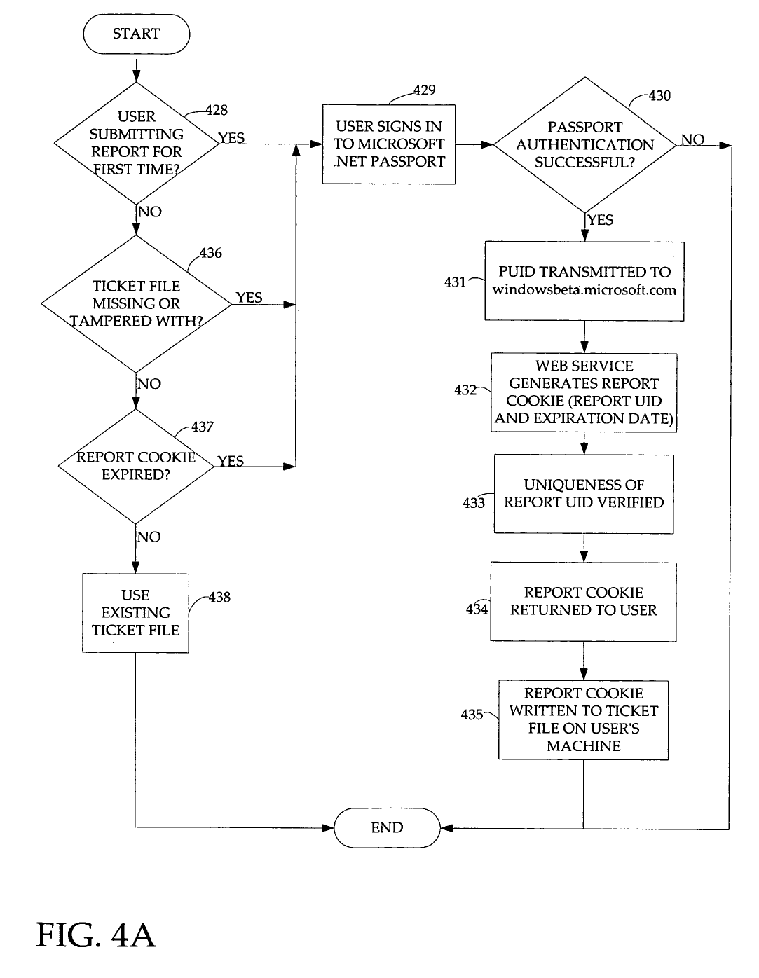

Turning now to FIG. 4, there is shown a flowchart illustrating an exemplary set of steps carried out by a software user who uses a problem-reporting client in accordance with an embodiment of the invention. The view presented in FIG. 4 generally assumes that the user is creating a new report following the experience of a bug or other issue. It should be noted, however, that in a particular embodiment, when the user launches the client, the user has the option of completing a report begun in an earlier session, and of uploading a report that was previously completed offline, in addition to beginning a new report.

With reference to FIG. 4, at step 401 the user launches the client in order to create a new report. During step 402, the client determines whether there is a record of a most recently loaded RPF. If so, and if the client finds that RPF, the client loads the RPF during step 403. If no record of a most recently loaded RPF is found, or if the most recently loaded RPF itself cannot be found (as, for example, if the client is being run for the first time, or if the last-loaded RPF has been deleted), during step 404 the client loads the first valid RPF it finds. During step 405 the user decides whether to select a different RPF, assuming that the loaded RPF presents this option and that there are other available RPFs stored on the user's system. The user might do this, for example, if the RPF loaded at steps 403 or 404 does not correspond to the product with respect to which the user had encountered a bug. If the user selects a different RPF, the client loads it during step 407. During step 409 the client parses the loaded RPF and, possibly, one or more additional XML files specified in the RPF. During step 411 the client constructs user interface elements based on the specifications in the loaded RPF and comprising a customized problem report questionnaire for the corresponding software product. During step 413 the user supplies input in response to questions and requests for information presented in the user interface. During step 415, based on the parsed XML file or files, the client determines whether the user's responses require additional specified XML files to be loaded and parsed in order to display additional child screens. If so, the client returns to step 409 with respect to those additional XML files; it can be seen that this process can repeat multiple times, reflecting the dynamic configurability of the problem report user interface.

During step 417, the user adds to the report the names of any files that the user believes will be useful to developers in reproducing the encountered issue. The client gathers the required and user-supplied files that will accompany the report during step 419. At step 423 the user saves the report. The user decides at step 425 whether to file anonymously (i.e., without submission of hardware configuration information, contact information, and user authentication credentials).

If the user is not anonymous, the client initiates a process of authentication of the user during step 427. The flowchart of FIG. 4A provides a summary illustration of exemplary component steps of the user authentication process. If the user is submitting a report to the reporting server for the first time (step 428), the client prompts the user at step 429 to sign in to the Microsoft® .NET Passport web authentication service; the user connects to the Internet if necessary in order to sign in. If the user is properly authenticated by Passport (step 430), the user's Passport User ID (PUID) is transmitted to the reporting server during step 431. (In the illustrated embodiment, the server is the site windowsbeta.microsoft.com.) At the server, during step 432, a web service generates a report cookie, comprising a Report User ID (Report UID) and an expiration date, for the user. The Report UID is a cryptographically random 64-bit signed integer, unique to the user's PUID. The uniqueness of the identifier is verified at step 433, and the report cookie is returned to the user during step 434. The report cookie is written to an XML “ticket file” stored on the user's machine (step 435). Storing the Report UID in a clear-text file does not compromise security because the identifier is sufficiently unique and random. The ticket file is used to facilitate offline report generation. If the user has previously submitted a report to the reporting server with authentication, but the user's ticket file is missing or has been tampered with (step 436), or if the report cookie has expired (step 437), the user is prompted to sign in to Passport at step 429 as if submitting a report for the first time.

Returning now to FIG. 4, at step 439, with respect to a non-anonymous user, the client gathers hardware configuration information, storing it in an XML file. The client checks all child screens during step 441 to ensure that all required fields have been filled in by the user. If a required field has not been completed, the user is prompted at step 443 to supply the missing information. During step 449 all completed user interface screens are stored as a single report XML file, which also contains the list of files being submitted with the report. During step 451 the report file, the hardware information file, all required and user-supplied supporting files, and user authentication information are packaged into a compressed report cabinet file, which is saved locally. If the user is filing a report online (step 453), the user uploads the report to the reporting server during step 455. If the user is completing the report offline, the report will be uploaded at a later time (step 457).

With respect to the flow diagrams of FIGS. 3, 4, and 4A, those skilled in the art will appreciate that the order of many of the illustrated steps can be altered, and that many steps can be combined, omitted, or supplemented without departing from the substance of the depicted embodiment and of the invention generally. For example, in an alternative embodiment the client provides the user with the option of checking the status of a previously-reported issue.

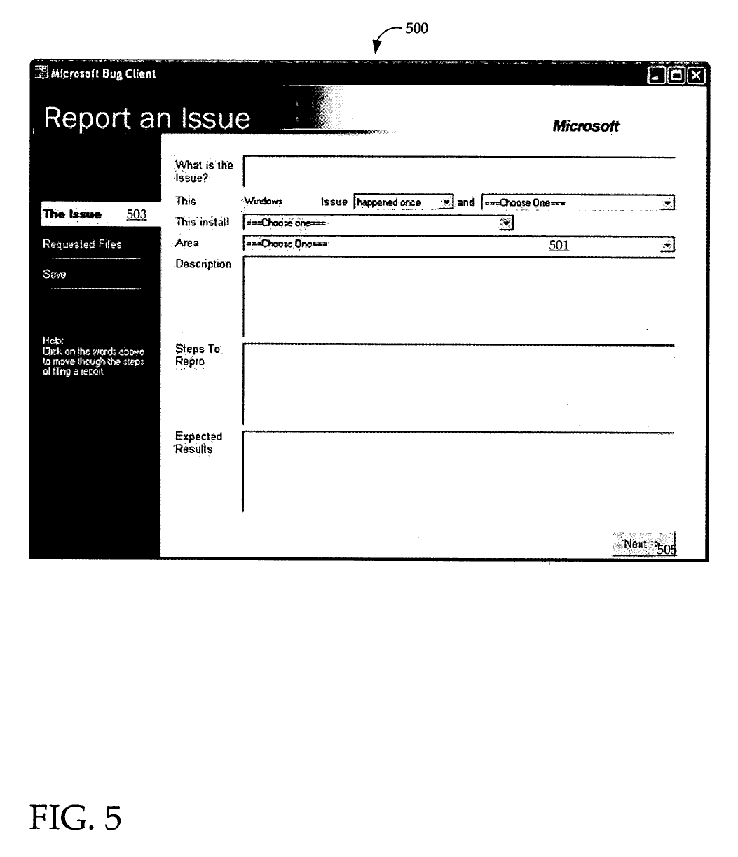

Turning now to FIGS. 5-9, there are shown illustrative screenshots of an exemplary user interface for a bug report client in accordance with an embodiment of the present invention. The contemplated user in this embodiment is a beta-testing customer. In each of these illustrations, the display includes a child screen, comprising the region with the white background in the lower right portion of the screenshot.

FIG. 5 illustrates a basic user interface display 500. The appearance of this display is defined in an RPF and is customizable. Each tab on the left side of the display 500 corresponds to a UIDF. The customer navigates through the various available child screens by clicking either on a tab, such as the selected “The Issue” tab 503, or on the “Next” button 505.

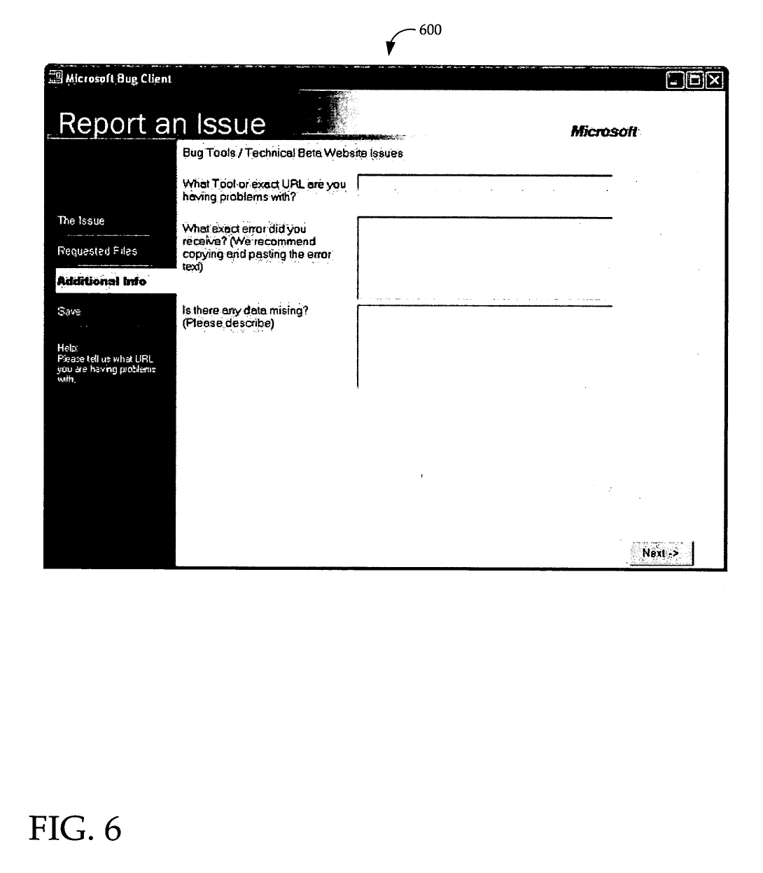

FIG. 6 illustrates an “Additional Info” screen 600. This display is a child screen that is dynamically generated and added to the interface in response to customer input. In the embodiment illustrated in FIGS. 5-9, the Additional Info display 600 is specifically generated when the customer selects, in the “Area” drop down list 501 in FIG. 5, the item “Bug Reporting Tools/Website” (not shown), and the Additional Info display 600 accordingly requests information from the customer relating to either such tools or a beta-testing website.

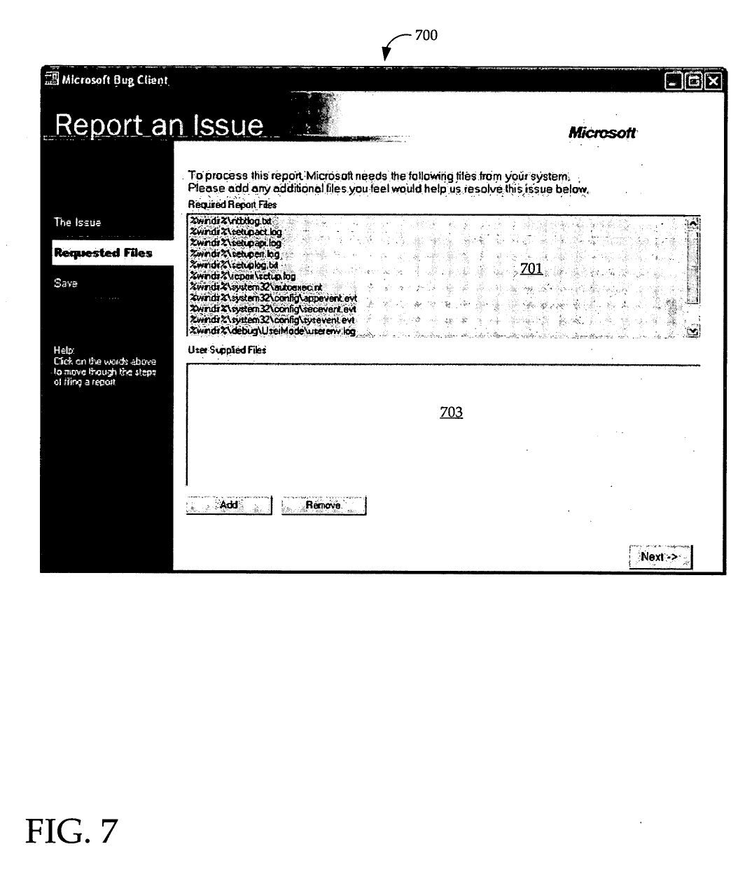

FIG. 7 illustrates a “Requested Files” child screen 700. The read-only list 701 displays names of files, such as system log files, that are specified in the RPF as being required for a report. The customer can specify in a space 703 within the screen additional files to support the report, such as a memory dump file.

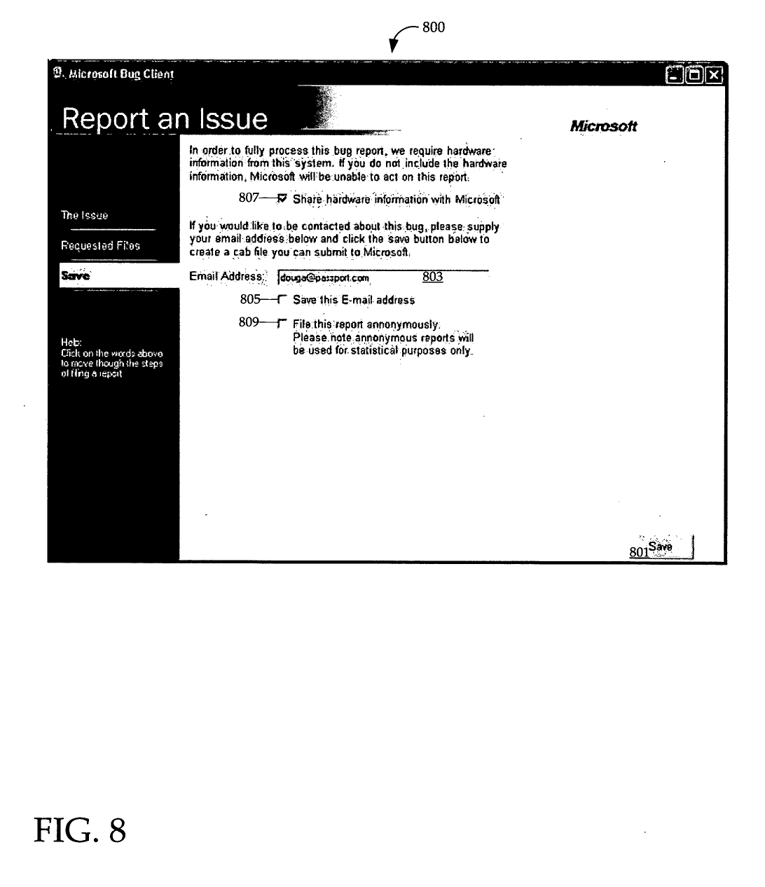

FIG. 8 illustrates a “Save” screen 800. The Save screen 800 includes text instructing the customer to click the Save button 801 to validate and save a report to a .cab file for submission to the reporting server. In one embodiment, after the customer clicks the ‘Save’ button 801, a new text label is displayed thanking the customer for reporting the issue and providing instructions regarding how to transmit the report. The Save screen 800 also displays text indicating that the user should supply a contact e-mail address in a presented text box 803. The Save screen 800 further includes a “Save this E-mail address” check box 805 which, when checked, causes the user's e-mail address to be saved for automatic population in subsequent reports. The text box 803 will be automatically populated if the user has previously filed a report with a valid e-mail address and with the check box 805 checked.

The Save screen 800 further includes text encouraging the customer to submit gathered hardware configuration information to assist in the processing and analysis of the report, and a check box 807 which, if not checked, prevents the customer's hardware configuration information from being submitted; here the check box 807 has been checked. In another embodiment, the Save screen allows the user to view hardware configuration information before it is uploaded to the reporting server. The Save screen 800 also includes a check box 809 allowing the customer to file the report anonymously (without submission of hardware information, Report UID authentication, or the customer's e-mail address). In another embodiment a save screen permits the user to save a report for future editing and to load a previously saved report.

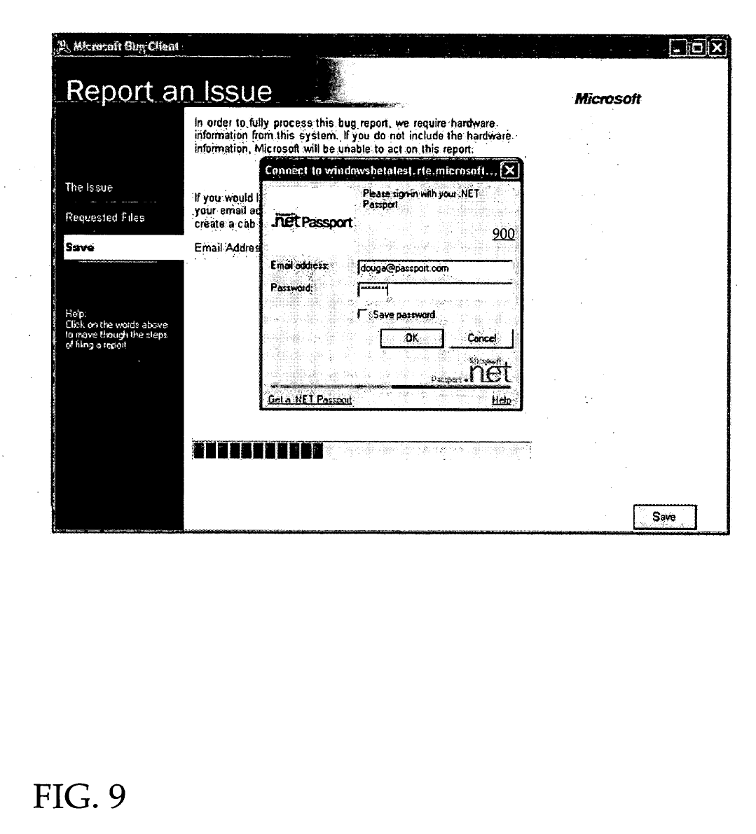

FIG. 9 illustrates a Microsoft® .NET Passport login screen 900 that is displayed to the customer after the customer chooses to upload the problem report to the beta-testing web server.

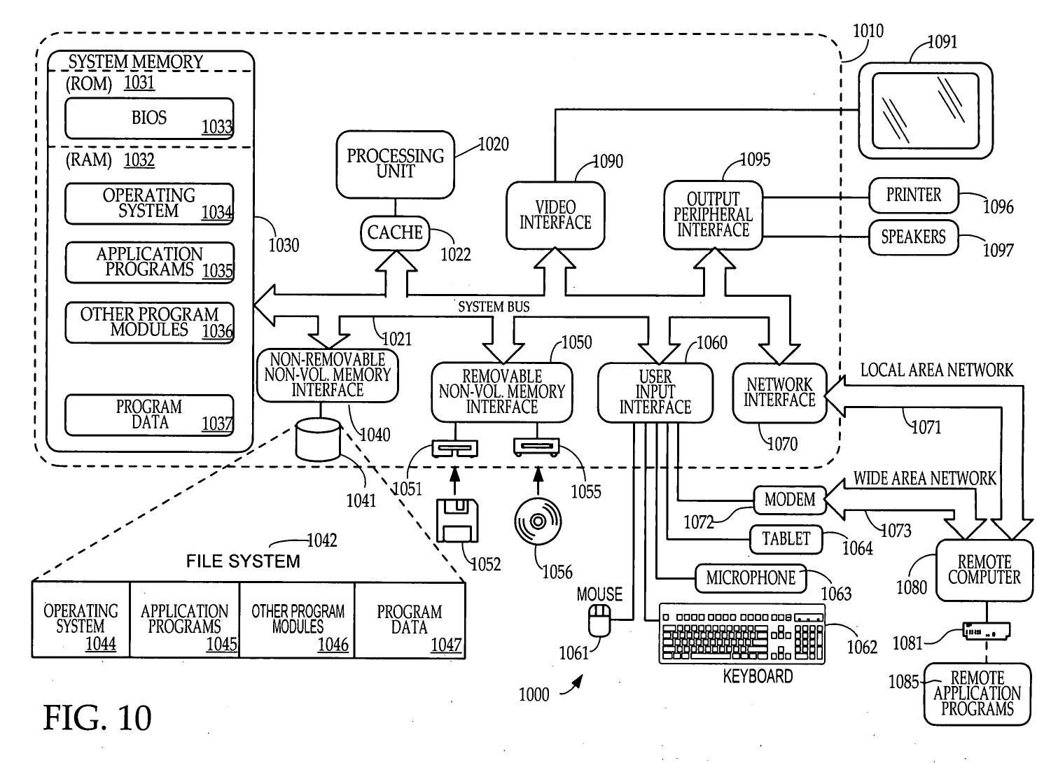

FIG. 10 illustratively depicts an example of a suitable operating environment 1000 for a computing device within which a problem-reporting client in accordance with the invention may be used, in a larger computing environment that can include one or more networks accessed by various communications media. The operating environment 1000 is only one example of a suitable operating environment, and it is not intended to suggest any limitation as to the scope of use or functionality of the invention. Other suitable computing environments for use with the invention include any computing device or computing system that supports interaction between user and machine.

The invention may be described in the general context of computer-executable instructions and computer-readable data being executed and read by a computing machine, including program modules. Program modules are broadly defined to include such elements as routines, programs, objects, components, and data structures, designed to perform particular tasks or to implement particular abstract data types. The invention is potentially incorporated within a distributed computing environment comprising a plurality of network nodes, in which certain tasks are performed by remote computing devices linked through a data communications network. In a distributed computing environment, program modules are generally located in both local and remote computer storage media.

With continued reference to FIG. 10, an exemplary system for implementing features of the present invention includes a general-purpose stored-program computer machine 1010, which can be connected to one or more other computer-based resources, such as a remote computer 1080 connected to the computer machine 1010 by way of a local area network 1071 or a wide area network 1073. The remote computer 1080 can function as a server in relation to the computer 1010 and typically includes many or all of the elements described herein with respect to the computer 1010. The computer machine 1010 includes at least one central processing unit 1020 connected by a system bus 1021 to a primary memory 1030. One or more levels of a cache memory 1022, connected to or situated within the processing unit 1020, act as a buffer for the primary memory 1030. Programs, comprising sets of instructions and associated data for the machine 1010, are stored in the memory 1030, from which they can be retrieved and executed by the processing unit 1020. Among the programs and program modules stored in the memory 1030 are those that comprise an operating system 1034.

The exemplary computer machine 1010 further includes various input/output devices and media. A user may enter commands and information into the computer 1010 through input devices such as a keyboard 1062 and pointing device 1061. These and other input devices are often connected to the processing unit 1020 through an interface 1060 that is coupled to the system bus 1021, but they may be connected by other interface and bus structures, such as a universal serial bus. Output devices and media can include a monitor or other type of display 1091, and a printer 1096, and include secondary storage devices such as a non-removable magnetic hard disk 1041, a removable magnetic disk 1052, and a removable optical disk 1056. Such computer-readable media provide nonvolatile storage of computer program modules and data. The hard disk 1041 is also commonly used along with the primary memory 1030 in providing virtual memory. It will be appreciated by those skilled in the art that other kinds of computer-readable media that can provide volatile and nonvolatile storage of data can also be used in the exemplary computing environment 1000. The computer 1010 has a file system 1042 associated with the operating system 1034. The file system serves as an interface that maps a set of logically-organized named files to data physically stored on secondary storage media, such as data stored in clusters or sectors on the hard disk 1041.

It will be appreciated by those skilled in the art that a new and useful method and framework for facilitating, preparing and submitting issue and problem reports by a software user and to a software provider has been described herein. More particularly, an extensible and dynamically-configurable problem-reporting client situated on a user's computer can be used to provide customized product-specific and user-specific reports to software product developers. In view of the many possible computing environments to which the principles of this invention may be applied, it should be recognized that embodiments described herein are meant to be illustrative and should not be deemed to limit the scope of the invention. Those skilled in the art to which the present invention applies will appreciate that the illustrative embodiments disclosed herein can be modified in arrangement and detail without departing from the spirit of the invention. For example, process steps described herein may be interchangeable with other steps in order to achieve the same result. Therefore, the invention as described herein,contemplates all such embodiments as may come within the scope of the following claims and equivalents thereof.

1. A system for reporting information regarding use of one or more software products, comprising:
a report user interface;
one or more sets of report user interface definition files, wherein a set of report user interface definition files customizes the report user interface for reporting information regarding a particular software product; and
a report client for presenting the report user interface.

2. The system of claim 1 wherein the report user interface facilitates reporting information regarding a problem encountered by a software user.

3. The system of claim 1, further comprising:
a report file generated by the client, wherein the report file is based on information entered by way of the report user interface.

4. The system of claim 3, further comprising:
a server to which the report file can be transmitted by the client.

5. The system of claim 3 wherein the report file can be saved in incomplete form in a first session in which the client is run, wherein the report file can be completed in a later session in which the client is run.

6. The system of claim 3, further comprising:
a report package generated by the client, wherein the report package contains the report file and additional report information.

7. The system of claim 6 wherein the report package comprises a cabinet file.

8. The system of claim 6 wherein the additional report information includes hardware information for a computer operated by a software user.

9. The system of claim 6 wherein the additional report information includes files required in accordance with the set of report user interface definition files.

10. The system of claim 6 wherein the additional report information includes files designated by a software user.

11. The system of claim 1 wherein the one or more sets of files comprise one or more text files formatted in accordance with a markup language.

12. The system of claim 11 wherein the one or more text files are formatted in accordance with Extensible Markup Language (XML).

13. The system of claim 12 wherein the client comprises an XML control parser.

14. The system of claim 1 wherein the report user interface is dynamically configurable based on information entered by a software user.

15. The system of claim 1 wherein a set of report user interface definition files comprises:
a report parent file; and
one or more additional report user interface definition files, wherein an additional report user interface definition file corresponds to a child screen in the report user interface.

16. The system of claim 1, further comprising a user authentication component for obtaining identification credentials for a software user.

17. A method for obtaining information regarding use of a software product, the method comprising:
obtaining information reported by a user of the software product by way of a general report client and one or more report user interface definition files, wherein the report user interface definition files specify a user interface presented by the general report client and customized with respect to the software product; and
modifying the one or more report user interface definition files based on the information reported by the user.

18. The method of claim 17 wherein the user is a beta-testing user.

19. The method of claim 17 wherein the one or more report user interface definition files comprise one or more text files formatted in accordance with a markup language.

20. The method of claim 19 wherein the one or more text files are formatted in accordance with Extensible Markup Language (XML).

21. A method for debugging a computer program, the method comprising:
obtaining bug information reported by a user of the computer program by way of a general report client and one or more report user interface definition files, wherein the one or more report user interface definition files specify a user interface that is presented by the general report client and customized for reporting on the computer program; and
modifying source code for the computer program based on the bug information.

22. The method of claim 21 wherein the one or more report user interface definition files comprise one or more text files formatted in accordance with a markup language.

23. The method of claim 22 wherein the one or more text files are formatted in accordance with Extensible Markup Language (XML).

24. The method of claim 21, further comprising:
modifying the one or more report user interface definition files based on the bug information reported by the user.

25. A method for reporting, by a user, information regarding use of a software product, the method comprising:
running a report client;
causing the client to load one or more report user interface definition files customized with respect to the software product;
entering information in a report user interface displayed by the client; and
uploading a completed report to a server.

26. The method of claim 25 wherein the entering information causes the client to load one or more additional report user interface definition files.

27. The method of claim 25, further comprising:
deciding whether to submit an anonymous report.

28. The method of claim 25, further comprising:
naming one or more files to be submitted with the completed report.

29. The method of claim 25, further comprising:
saving an incomplete report in a first session in which the report client is run; and
completing the incomplete report in a subsequent session in which the report client is run.

30. A method for authenticating a user submitting a report on a software product, the method comprising:
generating a report user identification for the user; and
generating an expiration date for the user.

31. The method of claim 30 wherein the report user identification comprises a cryptographically-random signed 64-bit integer.

32. The method of claim 30, further comprising:
causing the report user identification and the expiration date to be stored in a ticket file on a computer operated by the user.

33. The method of claim 32 wherein the ticket file is a text file formatted in accordance with a markup language.

34. The method of claim 33 wherein the ticket file is formatted in accordance with Extensible Markup Language (XML).

35. The method of claim 30 wherein the generating the report user identification and the generating the expiration date are accomplished by way of a web service.

36. A computer-readable medium having computer-executable instructions for implementing a method for obtaining information regarding use of a software product, the method comprising:
obtaining information reported by a user of the software product by way of a general report client and one or more report user interface definition files, wherein the report user interface definition files specify a user interface presented by the general report client and customized with respect to the software product; and
modifying the one or more report user interface definition files based on the information reported by the user.

37. A computer-readable medium having computer-executable instructions for implementing a method for debugging a computer program, the method comprising:
obtaining bug information reported by a user of the computer program by way of a general report client and one or more report user interface definition files, wherein the one or more report user interface definition files specify a user interface that is presented by the general report client and customized for reporting on the computer program; and
modifying source code for the computer program based on the bug information.

38. A computer-readable medium storing computer-executable instructions and computer-readable data comprising an executable client for facilitating preparation of a report by a user on a software product, wherein the executable client implements a method comprising:
loading and parsing one or more report user interface definition files associated with the software product; and
causing a display of a report user interface customized for reporting information regarding the software product.

39. The computer-readable medium of claim 38 wherein the one or more report user definition files are formatted in accordance with a markup language.

40. The computer-readable medium of claim 38 wherein the markup language is Extensible Markup Language (XML).

41. A computer-readable medium storing computer-readable data comprising:
one or more report user interface definition files, wherein the one or more report user interface definition files specify a report user interface customized for reporting information regarding use of a particular software product, and wherein the one or more report user interface definition files are capable of being read by a general report client.
